(19) United States
(12) Patent Application Publication
(10) Pub. No.: US 2026/0285123 A1
(43) Pub. Date: Sep. 24, 2026

(54) SYSTEM, INFORMATION PROCESSING APPARATUS, AND METHOD

(71) Applicant: TOYOTA JIDOSHA KABUSHIKI KAISHA, Toyota-shi Aichi-ken (JP)

(72) Inventor: Keizoh KAWAGUCHI, Okazaki-shi Aichi-ken (JP)

(73) Assignee: TOYOTA JIDOSHA KABUSHIKI KAISHA, Toyota-shi Aichi-ken (JP)

(21) Appl. No.: 19/568,034

(22) Filed: Mar. 16, 2026

(30) Foreign Application Priority Data
Mar. 19, 2025 (JP) 2025-045966

(51) Int. Cl. B60H 1/00; G07C 5/02; G07C 5/08

(52) U.S. Cl. CPC B60H 1/00657; B60H 1/00778; G07C 5/0816; G07C 5/02

(57) ABSTRACT

An information processing apparatus for controlling the air conditioning of a vehicle accepts, from a terminal apparatus, information on an operation input to control the air conditioning of the vehicle. The information processing apparatus then acquires the states of the vehicle. The states of the vehicle include the power state of the vehicle and the gear position of the vehicle. The information processing apparatus controls the air conditioning of the vehicle based on the operation input when the ignition power of the vehicle is ON and the vehicle is in a non-driving state.

### CROSS-REFERENCE TO RELATED APPLICATION

This application claims priority to Japanese Patent Application No. 2025-045966 filed on Mar. 19, 2025, the entire contents of which are incorporated herein by reference.

### TECHNICAL FIELD

The present disclosure relates to a system, an information processing apparatus, and a method.

### BACKGROUND

Technology for remote air conditioning control that allows users to control the air conditioning apparatuses of vehicles from terminal apparatuses even when the users are away from the vehicles is known. For example, Patent Literature (PTL) 1 discloses technology for starting, based on a request transmitted from a terminal apparatus, an air conditioning mode that operates air conditioning, in a state of prohibiting travel, finishing the air conditioning mode when a first period has elapsed, and extending the first period when a predetermined condition is met.

### CITATION LIST

### Patent Literature

PTL 1: JP 2022-132778 A

### SUMMARY

It is assumed that conventional remote air conditioning control is performed while a vehicle is in a stopped (ignition power OFF: IGOFF) state. In PTL 1, the vehicle finishes remote air conditioning control upon detecting an operation to turn the ignition ON. However, there are cases in which remote air conditioning control is necessary regardless of the power state of the vehicle, such as when a pet is left inside the vehicle while the user is away. The conventional remote air conditioning control does not consider performing remote air conditioning control while the ignition power of the vehicle is ON. Therefore, there is room for improvement in technology related to remote air conditioning control.

It would be helpful to improve technology related to remote air conditioning control.

A system according to an embodiment of the present disclosure is a system including:
a terminal apparatus; and
an information processing apparatus configured to control the air conditioning of a vehicle,
wherein
the terminal apparatus is configured to:
   accept an operation input to control the air conditioning of the vehicle; and
   transmit information on the operation input to the information processing apparatus, and
the information processing apparatus includes:
   a communication interface configured to receive the information on the operation input from the terminal apparatus;
   sensors configured to detect the power state of the vehicle and the gear position of the vehicle; and
   a processor configured to control an air conditioning apparatus of the vehicle based on the operation input when the ignition power of the vehicle is ON and the vehicle is in a non-driving state.

An information processing apparatus according to an embodiment of the present disclosure is an information processing apparatus configured to control the air conditioning of a vehicle, the information processing apparatus including a controller configured to:
accept, from a terminal apparatus, information on an operation input to control the air conditioning of the vehicle; and
control the air conditioning of the vehicle based on the operation input when the ignition power of the vehicle is ON and the vehicle is in a non-driving state.

A method according to an embodiment of the present disclosure is a method to be performed by an information processing apparatus, the method including:
accepting, from a terminal apparatus, information on an operation input to control the air conditioning of a vehicle;
acquiring the states of the vehicle, the states of the vehicle including the power state of the vehicle and the gear position of the vehicle; and
controlling the air conditioning of the vehicle based on the operation input when the ignition power of the vehicle is ON and the vehicle is in a non-driving state.

According to an embodiment of the present disclosure, technology related to remote air conditioning control is improved.

### BRIEF DESCRIPTION OF THE DRAWINGS

In the accompanying drawings:

FIG. 1 is a diagram illustrating a schematic configuration of a system according to an embodiment of the present disclosure;

FIG. 2 is a block diagram illustrating a schematic configuration of an information processing apparatus according to an embodiment of the present disclosure;

FIG. 3 is a block diagram illustrating a schematic configuration of a terminal apparatus according to an embodiment of the present disclosure; and

FIG. 4 is a flowchart illustrating operations of the information processing apparatus according to an embodiment of the present disclosure.

### DETAILED DESCRIPTION

Hereinafter, an aspect for implementing the present disclosure will be described with reference to the drawings. In each figure, the same reference numerals indicate the same or equivalent components.

### Outline of Embodiment

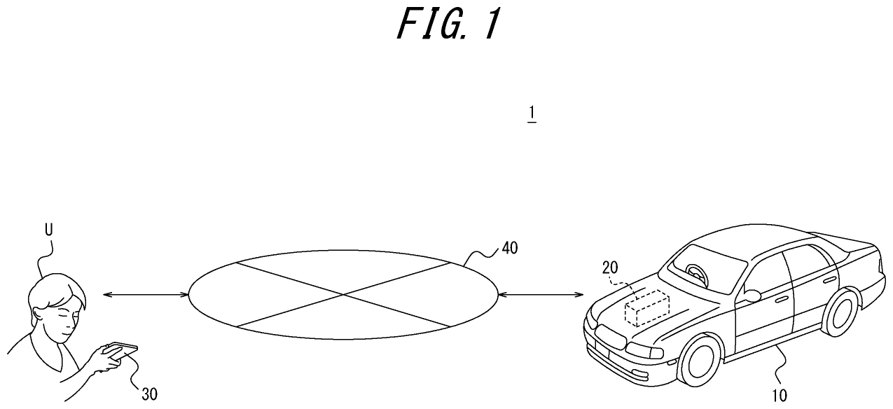

An outline of a system 1 according to an embodiment of the present disclosure will be described with reference to FIG. 1. The system 1 includes an information processing apparatus 20 configured to control the air conditioning of a vehicle 10, and a terminal apparatus 30 of a user U. The information processing apparatus 20 of the vehicle 10 and the terminal apparatus 30 are communicably connected to each other via a network 40 including, for example, the Internet, a mobile communication network, and the like.

The vehicle 10 is an automobile, for example, but is not limited to this and may be any appropriate vehicle. The automobile is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The number of vehicles 10 provided in the system 1 may be freely determined.

In the present embodiment, the information processing apparatus 20 is mounted in the vehicle 10. The information processing apparatus 20 is, for example, a computer or a dedicated electronic device such as an Electronic Control Unit (ECU). The information processing apparatus 20 can communicate with the terminal apparatus 30 via the network 40.

The terminal apparatus 30 is any apparatus used by the user U. For example, a general purpose electronic device such as a smartphone, a personal computer (PC), or a tablet terminal, or a dedicated electronic device may be used as the terminal apparatus 30. The terminal apparatus 30 can communicate with the information processing apparatus 20 in the vehicle 10 via the network 40. FIG. 1 illustrates one terminal apparatus 30 in the system 1, but this is not limiting. The system 1 may include two or more terminal apparatuses 30.

The network 40 includes the Internet, at least one wide area network (WAN), at least one metropolitan area network (MAN), or a combination thereof. The network 40 may include at least one wireless network, at least one optical network, or a combination thereof. The wireless network is, for example, an ad hoc network, a cellular network, a wireless local area network (LAN), a satellite communication network, or a terrestrial microwave network.

First, an outline of an embodiment of the present disclosure will be described, and details will be described later. The information processing apparatus 20 (or the controller thereof) accepts, from the terminal apparatus 30 of the user U, information on an operation input to control the air conditioning of the vehicle 10. The information processing apparatus 20 then acquires the states of the vehicle 10. The states of the vehicle 10 include the power state of the vehicle 10 and the gear position of the vehicle 10. The information processing apparatus 20 controls the air conditioning of the vehicle 10 based on the operation input when the ignition power of the vehicle 10 is ON and the vehicle 10 is in a non-driving state. The air conditioning controls the in-vehicle temperature, humidity, air volume, and air direction, the operation state (cooling, heating, or dehumidifying) of the air conditioner, and the operation states of the seat heaters and the like.

As described above, according to the present embodiment, when the user U operates the terminal apparatus 30 to start controlling the air conditioning of the vehicle 10, information on the operation input is transmitted. Upon receiving the information on the operation input for controlling the air conditioning, the information processing apparatus 20 acquires the states of the vehicle 10. When the ignition power of the vehicle 10 is ON and the vehicle 10 is in a non-driving state, the information processing apparatus 20 controls the air conditioning apparatus of the vehicle 10 based on the operation input from the terminal apparatus 30. However, when the ignition power of the vehicle 10 is ON and the vehicle 10 is in motion or may be driven, the air conditioning is not controlled based on the operation input from the terminal apparatus 30. The reason for this is that changing the air conditioning while the vehicle 10 is in motion (driven) may confuse the driver and increase the risk of an accident. According to the present embodiment, when the vehicle 10 is in a non-driving state, the air conditioning can be remotely controlled. According to the present disclosure, remote air conditioning control becomes possible even when the ignition power of the vehicle 10 is ON, provided that safety is ensured. Therefore, technology related to remote air conditioning control is improved.

Next, configurations of the system 1 will be described in detail.

### (Configuration of Information Processing Apparatus of Vehicle)

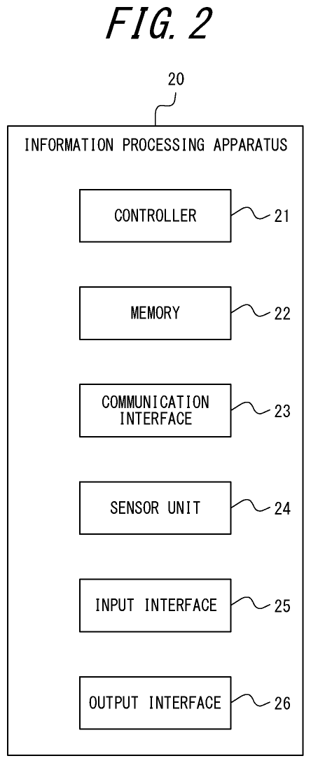

As illustrated in FIG. 2, the information processing apparatus 20 in the vehicle 10 includes a controller 21, a memory 22, a communication interface 23, a sensor unit 24, an input interface 25, and an output interface 26.

The controller 21 includes at least one processor, at least one programmable circuit, at least one dedicated circuit, or a combination of these. The processor is, for example, a general purpose processor such as a central processing unit (CPU) or a graphics processing unit (GPU), or a dedicated processor specialized for specific processing, but is not limited to these. The programmable circuit is, for example, a field-programmable gate array (FPGA), but is not limited to this. The dedicated circuit is an application specific integrated circuit (ASIC), for example, but is not limited to this. The controller 21 controls operations of the entire information processing apparatus 20.

In one embodiment, upon receiving, from the terminal apparatus 30 of the user U, information on an operation input to control the air conditioning of the vehicle 10, the controller 21 of the information processing apparatus 20 controls the air conditioning of the vehicle 10 based on the operation input when the vehicle 10 is in a non-driving state.

The memory 22 includes one or more memories. The memories are, for example, semiconductor memories, magnetic memories, optical memories, or the like, but are not limited to these. The semiconductor memories are, for example, random access memory (RAM) or read only memory (ROM). The RAM is, for example, static random access memory (SRAM) or dynamic random access memory (DRAM). The ROM is, for example, electrically erasable programmable read only memory (EEPROM). The memories included in the memory 22 may each function as, for example, a main memory, an auxiliary memory, or a cache memory. The memory 22 stores any information to be used for operations of the information processing apparatus 20. For example, the memory 22 may store a system program, an application program, embedded software, and the like. The information stored in the memory 22 may be updated with, for example, information acquired from the network 40 via the communication interface 23.

The communication interface 23 includes at least one interface for communication to connect to the network 40. A plurality of the interfaces for communication may be included. The interface may be either a wired or wireless communication interface. For wired communication, the interface for communication is, for example, a local area network (LAN) interface or universal serial bus (USB). For wireless communication, the interface for communication is, for example, an interface compliant with a mobile communication standard such as Long Term Evolution (LTE), the 4th generation (4G), or the 5th generation (5G), or an interface compliant with a short-range wireless communication standard such as WiFi® (WiFi is a registered trademark in Japan, other countries, or both) or Bluetooth® (Bluetooth is a registered trademark in Japan, other countries, or both), but is not limited to these and may comply with any communication standard. The communication interface 23 receives data from outside or from in-vehicle apparatus or the like, and transmits data obtained by operations of the information processing apparatus 20. The information processing apparatus 20 communicates with the terminal apparatus 30 via the communication interface 23 and the network 40. In one embodiment, the communication interface 23 of the information processing apparatus 20 receives information on an operation input to control the air conditioning of the vehicle 10 from the terminal apparatus 30 of the user U.

The sensor unit 24 includes one or more sensors configured to acquire the states of the vehicle 10. Specifically, the sensor unit 24 includes a sensor configured to detect the power state (IGON or IGOFF) of the vehicle 10, a sensor configured to detect the gear position of the vehicle 10, and a sensor configured to detect the speed of the vehicle 10. Furthermore, the sensor unit 24 may include a sensor configured to detect the state of the parking brake, a temperature sensor configured to measure the in-vehicle temperature of the vehicle 10, and a global positioning system (GPS) configured to determine the position of the vehicle 10. The information processing apparatus 20 may include the sensor unit 24 as part of the apparatus 20, or may acquire the states of the vehicle 10 from sensors external to the information processing apparatus 20 via the communication interface 23 or the like.

The input interface 25 includes at least one interface for input. The interface for input is, for example, a physical key, a capacitive key, a pointing device, or a touch screen integrally provided with a display. The interface for input may be, for example, a microphone that accepts audio input, or a camera that accepts gesture input, or the like. The input interface 25 accepts an operation for inputting data to be used for operations of the information processing apparatus 20. The input interface 25 may be connected to the information processing apparatus 20 as an external input device, instead of being included in the information processing apparatus 20. As a connection method, any method such as Universal Serial Bus (USB), High-Definition Multimedia Interface (HDMI®; HDMI is a registered trademark in Japan, other countries, or both), or Bluetooth® can be used. In one embodiment, the input interface 25 of the information processing apparatus 20 may include an operation panel for controlling the air conditioning of the vehicle 10.

The output interface 26 includes at least one interface for output. The interface for output is, for example, a display for outputting information in the form of images, a speaker for outputting information in the form of audio, or the like. The display is, for example, a liquid crystal display (LCD) or an organic electro luminescent (EL) display. The output interface 26 displays and outputs data obtained by operations of the information processing apparatus 20. The output interface 26 may be connected to the information processing apparatus 20 as an external output device, instead of being included in the information processing apparatus 20. As a connection method, any method such as USB, HDMI®, or Bluetooth® can be used.

### (Configuration of Terminal Apparatus)

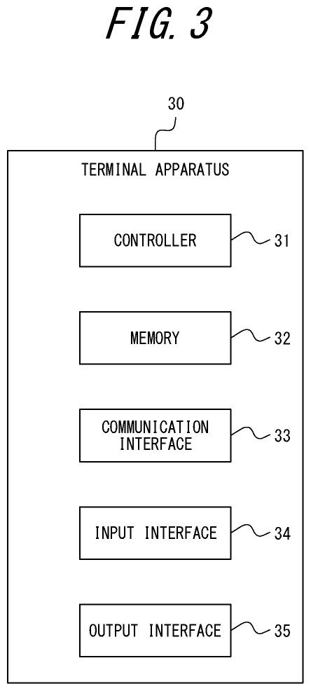

As illustrated in FIG. 3, the terminal apparatus 30 includes a controller 31, a memory 32, a communication interface 33, an input interface 34, and an output interface 35.

The controller 31 includes at least one processor, at least one programmable circuit, at least one dedicated circuit, or a combination of these. The processor is, for example, a general purpose processor such as a CPU or a GPU, or a dedicated processor specialized for specific processing, but is not limited to these. The programmable circuit is, for example, an FPGA, but is not limited to this. The dedicated circuit is, for example, an ASIC, but is not limited to this. The controller 31 controls operations of the entire terminal apparatus 30.

The memory 32 includes one or more memories. The memories are, for example, semiconductor memories, magnetic memories, optical memories, or the like, but are not limited to these. The memories included in the memory 32 may each function as, for example, a main memory, an auxiliary memory, or a cache memory. The memory 32 stores any information to be used for operations of the terminal apparatus 30. For example, the memory 32 may store a system program, an application program, a database, map information, and the like. The information stored in the memory 32 may be updated with, for example, information acquired from the network 40 via the communication interface 33.

The communication interface 33 includes at least one interface for communication to connect to the network 40. A plurality of the interfaces for communication may be included. The interface may be either a wired or wireless communication interface, but wireless communication is desirable. For wireless communication, the interface for communication is, for example, an interface compliant with a mobile communication standard such as LTE, 4G, or 5G, or an interface compliant with a short-range wireless communication standard such as WiFi® or Bluetooth®, but is not limited to these and may comply with any communication standard. The terminal apparatus 30 communicates with the information processing apparatus 20 in the vehicle 10 via the communication interface 33 and the network 40. In one embodiment, the communication interface 33 of the terminal apparatus 30 transmits information on an operation input to control the air conditioning of the vehicle 10 to the information processing apparatus 20.

The input interface 34 includes at least one interface for input. The interface for input is, for example, a physical key, a capacitive key, a pointing device, or a touch screen integrally provided with a display. The interface for input may be, for example, a microphone that accepts audio input, or a camera that accepts gesture input, or the like. The input interface 34 accepts an operation for inputting data to be used for operations of the terminal apparatus 30. The input interface 34 may be connected to the terminal apparatus 30 as an external input device, instead of being included in the terminal apparatus 30. In one embodiment, the input interface 34 of the terminal apparatus 30 accepts an operation input from the user U to control the air conditioning of the vehicle 10.

The output interface 35 includes at least one interface for output. The interface for output is, for example, a display for outputting information in the form of images, a speaker for outputting information in the form of audio, or the like. The display is, for example, an LCD or an organic EL display. The output interface 35 displays and outputs data obtained by operations of the terminal apparatus 30, data acquired via the communication interface 33, or the like. The output interface 35 may be connected to the terminal apparatus 30 as an external output device, instead of being included in the terminal apparatus 30.

### (Flow of Operations of Information Processing Apparatus)

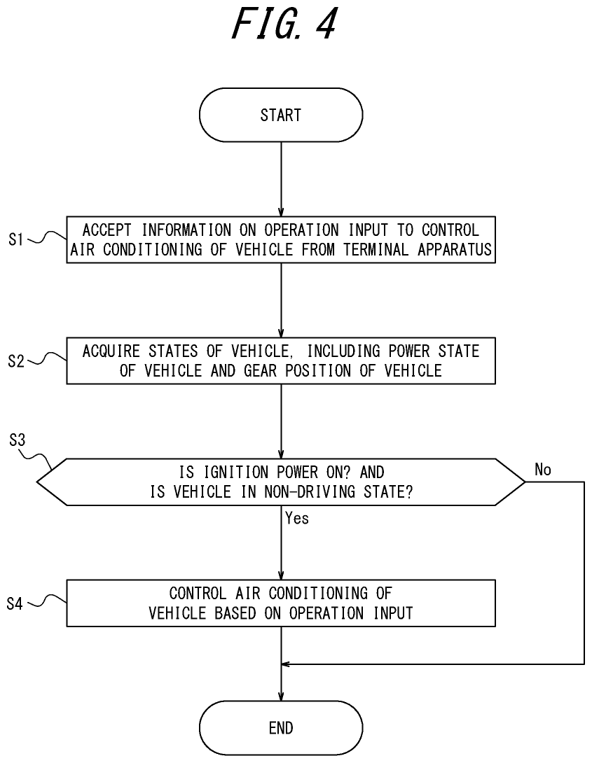

Operations of the information processing apparatus 20 (controller 21) according to one embodiment will be described with reference to the flowchart in FIG. 4.

In S1 of FIG. 4 (hereinafter, each step of the flowchart will be identified as S and a number), the controller 21 of the information processing apparatus 20 accepts, from the terminal apparatus 30 of the user U, information on an operation input to control the air conditioning of the vehicle 10.

Specifically, first, the user U operates the input interface 34 of the terminal apparatus 30 to launch an application (hereinafter referred to as “remote control app”) for controlling the vehicle 10 while being away from the vehicle 10. Here, the remote control app is assumed to provide multiple services. The user U selects, from the multiple services, a service (“remote air conditioning” service) to control the air conditioning of the vehicle 10. Then, the terminal apparatus 30 displays an air conditioning control screen for the vehicle 10 on the display (output interface) thereof. When the user U operates the air conditioning control screen, the terminal apparatus 30 accepts an operation input to control the air conditioning of the vehicle 10. The terminal apparatus 30 then transmits information on the operation input through the communication interface 33. The information processing apparatus 20 receives the information on the operation input for controlling the air conditioning from the terminal apparatus 30 through the communication interface 23.

In S2, after the acceptance of the information on the operation input for controlling the air conditioning, the controller 21 of the information processing apparatus 20 acquires the states of the vehicle 10. The states of the vehicle 10 include the power state of the vehicle 10 and the gear position of the vehicle 10.

Specifically, upon accepting the information on the operation input via the communication interface 23, the controller 21 acquires the states of the vehicle 10. The states of the vehicle 10 are collected using the sensor unit 24. For example, the sensor unit 24 detects the power state (IGON or IGOFF) of the vehicle 10. The sensor unit 24 also detects the gear position of the vehicle 10. The sensor unit 24 also detects the speed of the vehicle 10 using a speed sensor. Furthermore, the sensor unit 24 may detect the state of the parking brake.

In S3 of FIG. 4, the controller 21 of the information processing apparatus 20 determines whether the ignition power of the vehicle 10 is ON and whether the vehicle 10 is in a non-driving state. When it is determined that the ignition power is ON and the vehicle 10 is in a non-driving state (S3—Yes), the process proceeds to S4. On the other hand, when it is determined that the vehicle 10 is not in a non-driving state (S3—No), the process ends.

Specifically, the controller 21 of the information processing apparatus 20 first determines whether the ignition power of the vehicle 10 is ON. When the ignition power is ON, the controller 21 of the information processing apparatus 20 determines whether the vehicle 10 is in a non-driving state, based on the gear position of the vehicle 10. For example, when the vehicle 10 is an automatic transmission vehicle and the gear position (shift lever) of the vehicle 10 is in the P range (parking range), the controller 21 determines that the vehicle 10 is in a non-driving state. When the vehicle 10 is in a non-driving state, safety can be ensured. Therefore, even when the ignition power of the vehicle 10 is ON, the process proceeds to S4, allowing remote control of the air conditioning. The process when the ignition power is OFF can be set freely. In the present embodiment, when the ignition power is OFF, the vehicle 10 is usually in a non-driving state, so the determination of S3 is regarded as Yes. Then, the process proceeds to S4. This determination is based on the fact that conventionally remote air conditioning is possible when the ignition power is OFF.

The non-driving state of the vehicle 10 is not limited to when the gear position is in the P range. As an example, when the vehicle 10 is an automatic transmission vehicle, a state in which the vehicle speed is 0, the parking brake is applied, and the gear position (shift lever) of the vehicle 10 is in the N range (neutral range) is determined as the non-driving state of the vehicle 10. The controller 21 of the information processing apparatus 20 determines whether the vehicle is in a non-driving state, based on information on vehicle speed from the speed sensor, the state of the parking brake, and the gear position of the vehicle 10.

The non-driving state of the vehicle 10 may also be determined based on other conditions. As an example, when the vehicle 10 is a manual transmission vehicle, a state in which the vehicle speed is 0, the parking brake is applied, and the gear position (shift lever) of the vehicle 10 is in any of the N (neutral), 1 (first gear), and R (reverse) ranges is determined as the non-driving state of the vehicle 10. In the manual transmission vehicle, it is recommended to put the shift lever in the 1 (first gear) range when parking on an uphill slope. Also, in the manual transmission vehicle, it is recommended to put the shift lever in the R (reverse) range when parking on a downhill slope. Therefore, even when the gear position is in the 1 or R range, a state in which the vehicle speed is 0 and the parking brake is applied is determined as being parked (the vehicle 10 is in a non-driving state). The controller 21 of the information processing apparatus 20 determines whether the vehicle is in a non-driving state, based on information on vehicle speed from the speed sensor, the state of the parking brake, and the gear position of the vehicle 10.

Next, in S4, the controller 21 of the information processing apparatus 20 controls the air conditioning apparatus of the vehicle 10 based on the accepted operation input. The process then ends.

When the air conditioning apparatus of the vehicle 10 is controlled in S4, it is desirable to provide a notification inside the vehicle 10. For example, the controller 21 of the information processing apparatus 20 notifies inside the vehicle 10, via the output interface 26 (for example, voice output or display), that the air conditioning is controlled based on the operation input transmitted from the terminal apparatus 30. This prior notification prevents a person on board the vehicle 10 from being confused by sudden control of the air conditioning.

Also, when the determination result in S3 is No, it is desirable to provide a notification to the terminal apparatus 30. For example, the controller 21 of the information processing apparatus 20 transmits, to the terminal apparatus 30, a notification that the air conditioning of the vehicle 10 cannot be controlled and the reason therefor. The terminal apparatus 30 receives the notification via the communication interface 33, and displays the contents of the notification on the output interface (display or the like) 35. The user U can recognize, based on the output from the terminal apparatus 30, that the air conditioning of the vehicle 10 cannot be controlled.

As described above, according to the present embodiment, the information processing apparatus 20 accepts information on an operation input to control the air conditioning of the vehicle 10 from the terminal apparatus 30 of the user U. When the ignition power of the vehicle 10 is ON and the vehicle 10 is in a non-driving state, the information processing apparatus 20 controls the air conditioning based on the operation input from the terminal apparatus 30. According to the present embodiment, when the vehicle 10 is in a non-driving state, that is, when safety can be ensured, remote control of the air conditioning becomes possible. According to the present disclosure, remote control of the air conditioning becomes possible even when the ignition power of the vehicle 10 is ON. Therefore, technology related to remote air conditioning control is improved.

Supplementary explanation will be provided regarding the operations of the information processing apparatus 20 (or controller 21) illustrated in FIG. 4. In S4, when the air conditioning of the vehicle 10 is being controlled, the information processing apparatus 20 can accept a command for controlling the air conditioning through the input interface 25. For example, when a person on board the vehicle 10 does not want the air conditioning to be controlled from the terminal apparatus 30, or wants to further change air conditioning settings made from the terminal apparatus 30, the person can control the air conditioning using an operation panel (the input interface 25) inside the vehicle 10. Therefore, the information processing apparatus 20 prioritizes an operation input for controlling the air conditioning from the operation panel (the input interface 25) inside the vehicle 10, over the operation input for controlling the air conditioning from the terminal apparatus 30, and performs temperature control of the vehicle 10.

The information processing apparatus 20 may also output, to the terminal apparatus 30, environmental information related to air conditioning control. The environmental information may include the in-vehicle temperature, exterior temperature, humidity, in-vehicle CO2 concentration, the current operation states (cooling, heating, or dehumidifying mode, air volume, air direction, and set temperature) of the air conditioning, and the operation states of the seat heaters of the vehicle 10. The environmental information may also include information that should be considered during remote control of the air conditioning, such as the remaining battery level and energy consumption status of the vehicle 10. Alternatively, the environmental information may include images (including still images and moving images) inside the vehicle 10. Any method may be adopted for the acquisition processing of the environmental information. Real-time environmental data or images may be acquired by temperature sensors, a humidity sensor, a CO2 sensor, a battery management system, and cameras (for example, a wide-angle camera inside the vehicle and an infrared camera) corresponding to the environmental information.

For example, the information processing apparatus 20 transmits the environmental information on the vehicle 10 to the terminal apparatus 30 periodically or based on a request from the terminal apparatus 30. This allows the user U to perform appropriate control while grasping the current status of the air conditioning of the vehicle 10 through the terminal apparatus 30. The controller 21 of the information processing apparatus 20 may transmit the environmental information on the vehicle 10 to the terminal apparatus 30, after a predetermined time has elapsed since the air conditioning of the vehicle 10 was controlled based on the operation input from the terminal apparatus 30. In embodiments, the predetermined time is the time (about 5 to 10 minutes) required for in-vehicle environment (for example, in-vehicle temperature, in-vehicle humidity, and the like) to become approximately constant due to control of the air conditioning based on the operation input. The terminal apparatus 30 displays the received environmental information on the vehicle 10 on the output interface 35 (for example, a display). This allows the user U to know the latest environmental information on the vehicle 10 and confirm the results of the operation input from the terminal apparatus 30.

In the system 1 of the present embodiment, as illustrated in FIG. 1, the information processing apparatus 20 of the vehicle 10 and the terminal apparatus 30 of the user U can communicate directly, and transmit and receive information directly. However, the information processing apparatus 20 and the terminal apparatus 30 may transmit and receive information via a center server. At this time, the information processing apparatus 20 of the vehicle 10 accepts, via the center server, information on an operation input to control the air conditioning of the vehicle 10 from the terminal apparatus 30.

In the present embodiment, the information processing apparatus 20 is mounted in the vehicle 10. However, the information processing apparatus 20 is not limited to the in-vehicle apparatus. For example, in a variation, the information processing apparatus 20 may be part of the center server. In this variation, the information processing apparatus 20 acquires the states of the vehicle 10 (such as the power state of the vehicle 10 and the gear position of the vehicle 10) via the network 40, and controls the air conditioning apparatus of the vehicle 10 via the network 40.

It is also possible to cause a computer capable of executing any program to function as the information processing apparatus 20 described above. The program may be a program code, code segments, or the like for executing necessary tasks. The program causes a computer to execute operations of the information processing apparatus 20, thereby causing the computer to function as the information processing apparatus 20. That is, the computer executes the operations of the information processing apparatus 20 in accordance with the program to thereby function as the information processing apparatus 20.

In one embodiment, a computer temporarily stores a program recorded on a portable recording medium or a program transmitted from a server in the main memory. Then, the computer reads the program stored in the main memory using the processor, and executes processes in accordance with the read program using the processor. The computer may read the program directly from the portable recording medium, and execute processes in accordance with the program. Each time the computer receives a program from an external server, the computer may sequentially execute processes in accordance with the received program. Without transmitting a program from an external server to the computer, processing may be executed by a so-called application service provider (ASP) type service that realizes functions only by execution instructions and result acquisitions. The program encompasses information that is to be used for processing by an electronic computer and is thus equivalent to a program. For example, data that is not a direct command to a computer but has a property that regulates processing of the computer is “equivalent to a program” in this context.

In one embodiment, a program can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented. For example, a navigation apparatus mounted in the vehicle 10 may be equipped with some or all of the components of the information processing apparatus 20.

Examples of some embodiments of the present disclosure are described below. However, it should be noted that the embodiments of the present disclosure are not limited to these examples.

### Appendix 1

A system comprising:
a terminal apparatus; and
an information processing apparatus configured to control air conditioning of a vehicle,
wherein
the terminal apparatus is configured to:
   accept an operation input to control the air conditioning of the vehicle; and
   transmit information on the operation input to the information processing apparatus, and
the information processing apparatus comprises:
   a communication interface configured to receive the information on the operation input from the terminal apparatus;
   sensors configured to detect a power state of the vehicle and a gear position of the vehicle; and
   a processor configured to control an air conditioning apparatus of the vehicle based on the operation input when an ignition power of the vehicle is ON and the vehicle is in a non-driving state.

### Appendix 2

An information processing apparatus configured to control air conditioning of a vehicle, the information processing apparatus comprising a controller configured to:
accept, from a terminal apparatus, information on an operation input to control the air conditioning of the vehicle; and
control the air conditioning of the vehicle based on the operation input when an ignition power of the vehicle is ON and the vehicle is in a non-driving state.

### Appendix 3

The information processing apparatus according to appendix 2, wherein the non-driving state of the vehicle corresponds to a state in which a gear position of the vehicle is in a P range when the vehicle is an automatic transmission vehicle.

### Appendix 4

The information processing apparatus according to appendix 2 or 3, wherein the non-driving state of the vehicle corresponds to a state in which a vehicle speed is 0, a parking brake is applied, and a gear position of the vehicle is in an N range when the vehicle is an automatic transmission vehicle.

### Appendix 5

The information processing apparatus according to any one of appendices 2 to 4, wherein the non-driving state of the vehicle corresponds to a state in which a vehicle speed is 0, a parking brake is applied, and a gear position of the vehicle is in any of N, 1, and R ranges when the vehicle is a manual transmission vehicle.

### Appendix 6

The information processing apparatus according to any one of appendices 2 to 5, wherein the controller is configured to provide a notification inside the vehicle when controlling the air conditioning of the vehicle based on the operation input.

### Appendix 7

The information processing apparatus according to any one of appendices 2 to 6, wherein the controller is configured to notify the terminal apparatus that the air conditioning cannot be controlled when the ignition power of the vehicle is ON and the vehicle is in a drivable state.

### Appendix 8

The information processing apparatus according to any one of appendices 2 to 7, wherein the controller is configured to enable the air conditioning to be controlled via an operation panel inside the vehicle when controlling the air conditioning of the vehicle based on the operation input.

### Appendix 9

The information processing apparatus according to any one of appendices 2 to 8, wherein the controller is configured to transmit environmental information on the vehicle to the terminal apparatus after a predetermined time has elapsed since the air conditioning of the vehicle was controlled based on the operation input.

### Appendix 10

A method to be performed by an information processing apparatus, the method comprising:
accepting, from a terminal apparatus, information on an operation input to control air conditioning of a vehicle;
acquiring states of the vehicle, the states of the vehicle including a power state of the vehicle and a gear position of the vehicle; and
controlling the air conditioning of the vehicle based on the operation input when an ignition power of the vehicle is ON and the vehicle is in a non-driving state.

### Appendix 11

The method according to appendix 10, wherein the non-driving state of the vehicle corresponds to a state in which the gear position of the vehicle is in a P range when the vehicle is an automatic transmission vehicle.

### Appendix 12

The method according to appendix 10 or 11, wherein the non-driving state of the vehicle corresponds to a state in which a vehicle speed is 0, a parking brake is applied, and the gear position of the vehicle is in an N range when the vehicle is an automatic transmission vehicle.

### Appendix 13

The method according to any one of appendices 10 to 12, wherein the non-driving state of the vehicle corresponds to a state in which a vehicle speed is 0, a parking brake is applied, and the gear position of the vehicle is in any of N, 1, and R ranges when the vehicle is a manual transmission vehicle.

### Appendix 14

The method according to any one of appendices 10 to 13, comprising providing a notification inside the vehicle when the air conditioning of the vehicle is controlled based on the operation input.

### Appendix 15

The method according to any one of appendices 10 to 14, comprising notifying the terminal apparatus that the air conditioning cannot be controlled when the ignition power of the vehicle is ON and the vehicle is in a drivable state.

### Appendix 16

The method according to any one of appendices 10 to 15, comprising accepting control of the air conditioning of the vehicle via an operation panel inside the vehicle when the air conditioning of the vehicle is being controlled based on the operation input.

### Appendix 17

The method according to any one of appendices 10 to 16, comprising transmitting environmental information on the vehicle to the terminal apparatus after a predetermined time has elapsed since the air conditioning of the vehicle was controlled based on the operation input.

1. A system comprising:
a terminal apparatus; and
an information processing apparatus configured to control air conditioning of a vehicle,
wherein
the terminal apparatus is configured to:
accept an operation input to control the air conditioning of the vehicle; and
transmit information on the operation input to the information processing apparatus, and
the information processing apparatus comprises:
a communication interface configured to receive the information on the operation input from the terminal apparatus;
sensors configured to detect a power state of the vehicle and a gear position of the vehicle; and
a processor configured to control an air conditioning apparatus of the vehicle based on the operation input when an ignition power of the vehicle is ON and the vehicle is in a non-driving state.

2. An information processing apparatus configured to control air conditioning of a vehicle, the information processing apparatus comprising a controller configured to:
accept, from a terminal apparatus, information on an operation input to control the air conditioning of the vehicle; and
control the air conditioning of the vehicle based on the operation input when an ignition power of the vehicle is ON and the vehicle is in a non-driving state.

3. The information processing apparatus according to claim 2, wherein the non-driving state of the vehicle corresponds to a state in which a gear position of the vehicle is in a P range when the vehicle is an automatic transmission vehicle.

4. The information processing apparatus according to claim 2, wherein the non-driving state of the vehicle corresponds to a state in which a vehicle speed is 0, a parking brake is applied, and a gear position of the vehicle is in an N range when the vehicle is an automatic transmission vehicle.

5. The information processing apparatus according to claim 2, wherein the non-driving state of the vehicle corresponds to a state in which a vehicle speed is 0, a parking brake is applied, and a gear position of the vehicle is in any of N, 1, and R ranges when the vehicle is a manual transmission vehicle.

6. The information processing apparatus according to claim 2, wherein the controller is configured to provide a notification inside the vehicle when controlling the air conditioning of the vehicle based on the operation input.

7. The information processing apparatus according to claim 2, wherein the controller is configured to notify the terminal apparatus that the air conditioning cannot be controlled when the ignition power of the vehicle is ON and the vehicle is in a drivable state.

8. The information processing apparatus according to claim 2, wherein the controller is configured to enable the air conditioning to be controlled via an operation panel inside the vehicle when controlling the air conditioning of the vehicle based on the operation input.

9. The information processing apparatus according to claim 2, wherein the controller is configured to transmit environmental information on the vehicle to the terminal apparatus after a predetermined time has elapsed since the air conditioning of the vehicle was controlled based on the operation input.

10. A method to be performed by an information processing apparatus, the method comprising:
accepting, from a terminal apparatus, information on an operation input to control air conditioning of a vehicle;
acquiring states of the vehicle, the states of the vehicle including a power state of the vehicle and a gear position of the vehicle; and
controlling the air conditioning of the vehicle based on the operation input when an ignition power of the vehicle is ON and the vehicle is in a non-driving state.

11. The method according to claim 10, wherein the non-driving state of the vehicle corresponds to a state in which the gear position of the vehicle is in a P range when the vehicle is an automatic transmission vehicle.

12. The method according to claim 10, wherein the non-driving state of the vehicle corresponds to a state in which a vehicle speed is 0, a parking brake is applied, and the gear position of the vehicle is in an N range when the vehicle is an automatic transmission vehicle.

13. The method according to claim 10, wherein the non-driving state of the vehicle corresponds to a state in which a vehicle speed is 0, a parking brake is applied, and the gear position of the vehicle is in any of N, 1, and R ranges when the vehicle is a manual transmission vehicle.

14. The method according to claim 10, comprising providing a notification inside the vehicle when the air conditioning of the vehicle is controlled based on the operation input.

15. The method according to claim 10, comprising notifying the terminal apparatus that the air conditioning cannot be controlled when the ignition power of the vehicle is ON and the vehicle is in a drivable state.

16. The method according to claim 10, comprising accepting control of the air conditioning of the vehicle via an operation panel inside the vehicle when the air conditioning of the vehicle is being controlled based on the operation input.

17. The method according to claim 10, comprising transmitting environmental information on the vehicle to the terminal apparatus after a predetermined time has elapsed since the air conditioning of the vehicle was controlled based on the operation input.
